(19) United States
(12) Patent Application Publication
(10) Pub. No.: US 2011/0195247 A1
(43) Pub. Date: Aug. 11, 2011

(54) TRANSPARENT ELECTRODE INTEGRATED ENCAPSULATION MODULE AND MANUFACTURING METHOD THEREOF

(75) Inventors: Yong-Oon Hwang, Gyeonggi-do (KR); DongHo Kang, Gyeonggi-do (KR)

(73) Assignee: NOVATECH INDUSTRY CO., LTD., ChungChongBuk-Do (KR)

(21) Appl. No.: 12/729,357

(22) Filed: Mar. 23, 2010

(30) Foreign Application Priority Data
Feb. 8, 2010 (KR) 1020100011322

(51) Int. Cl. B32B 17/06; C03C 15/00; C03C 17/00

(52) U.S. Cl. 428/337; 65/30.1; 65/60.1; 428/426

(57) ABSTRACT

A configuration of a flat display panel with a touch screen panel loaded thereon in which reduced number of sheets of glass substrate or resin film substrate is provided. The configuration includes a transparent electrode integrated encapsulation module in which the transparent electrode is formed on one surface of an encapsulation glass substrate without a separate glass substrate for electrode formation of a touch screen circuit. A method for manufacturing the transparent electrode integrated encapsulation module is provided.

### CROSS-REFERENCE TO RELATED APPLICATIONS

This application claims the priority benefit of Korean Patent Application No. 10-2010-0011322, filed on Feb. 8, 2010. The entirety of the aforementioned application is incorporated by reference herein.

### BACKGROUND

I. Field of the Invention

The following description relates generally to a configuration of a flat display panel with a touch screen panel loaded thereon, and more particularly to touch screen circuit module configuration and a manufacturing method thereof.

II. Description of the Related Art

According to advantages of a touch screen that can form an input device simply without a separate keyboard or a keypad and be conveniently operated, the touch screen has been widely used in the flat panel display. Particularly, due to its low profile and light weight characteristics, the touch screen often used in portable electronic devices such as cellular phones or PDAs or digital cameras.

FIG. 1 illustrates a schematic configuration of conventional touch screen panel according to the prior art. Referring to FIG. 1, a bare glass substrate 11 is deposited with TFT circuits or an organic matter layer 12 for forming circuits or pixels. An encapsulation glass substrate 13 is placed for covering and sealing the bare glass substrate on which circuits or pixels are formed. A separate glass substrate or a resin film substrate 15 is placed for forming a transparent electrode 14 such as ITO. Another encapsulation glass substrate or a resin film substrate 16 is provided to protect such transparent electrode. The encapsulation glass substrate or resin film substrate 16 may have its own sealing function or sealing may be performed by a sealing means 17.

The touch screen panel formed with several sheets of glass substrates or resin films increases the manufacturing cost of the touch screen panel due to high price of a glass substrate or a resin film. Other disadvantages of the overlaying layers of sheets of glass substrates or resin films include reduced light transmission of the touch screen panel and increase in touch screen thickness and weight. Thus an effort to improve the performance of the touch screen panel formed with several sheets of glass substrates or resin films and reduce the manufacturing cost of the touch screen panel is needed.

To overcome the disadvantages of the overlaying layers of sheets of glass substrates or resin films, it was suggested to manufacture each of glass substrate for forming the touch screen panel to be thinner as far as possible. A glass substrate of 0.05 to 0 5 mm in thickness through sliming processes in the prior art, however, can causes a defect during the manufacturing of the touch screen panel formed with several sheets of glass substrates as the size of the touch screen panel increases and the strength of the slimmed glass decreased.

### SUMMARY

The following presents a simplified summary of one or more embodiments in order to provide a basic understanding of such embodiments. This summary is not an extensive overview of all contemplated embodiments.

A preferred embodiment of the present invention provides configuration of a flat display panel with a touch screen panel loaded thereon and a manufacturing method thereof by which can overcome the disadvantages of the overlaying layers of sheets of glass substrates or resin film substrates.

According to an aspect of the present invention, a configuration of a flat display panel with a touch screen panel loaded thereon in which reduced number of sheets of glass substrate or resin film substrate is provided. The configuration includes a transparent electrode integrated encapsulation module in which the transparent electrode is formed on one surface of an encapsulation glass substrate without a separate glass substrate for electrode formation of a touch screen circuit.

Yet another aspect of the present invention provides a method for manufacturing a flat panel display on which touch screen circuits with reduced number of sheets of glass substrate or resin film substrate are configured.

Another aspect of the present invention provides a transparent electrode integrated encapsulation module characterized by including a slimmed encapsulation glass substrate in thickness from 0.05 to 0.5 mm.

A further aspect of the present invention provides a method for manufacturing a transparent electrode integrated encapsulation module, which is characterized by including a step of slimming an encapsulation glass substrate in thickness from 0.05 to 0.5 mm.

Still another aspect of present invention provides a method for manufacturing a transparent electrode integrated encapsulation module, which is characterized by including a step of chemically tempering the slimed encapsulation glass substrate in thickness from 0.05 to 0.5 mm.

Another aspect of present invention provides a method for manufacturing a transparent electrode integrated encapsulation module, which is characterized by including a step of forming the transparent electrode on the slimmed and chemically tempered encapsulation glass substrate in thickness from 0.05 to 0.5 mm.

In addition to the exemplary aspects and embodiments described above, other aspects and embodiments will become apparent to those having ordinary skill in the art by reference to the drawings and by study of the following descriptions.

### BRIEF DESCRIPTION OF THE DRAWINGS

FIG. 1 is a sectional view of a touch screen panel module configuration in which a transparent electrode is formed in the prior art;

FIG. 2 is a sectional view of a touch screen panel module configuration in which a transparent electrode is formed accordance with a preferred embodiment of the present invention; and

FIG. 3 is a flow chart illustrating a sequence of a method for manufacturing transparent electrode integrated encapsulation module accordance with a preferred embodiment of the present invention.

### DETAILED DESCRIPTION

Hereinafter, preferred embodiments of the present invention will be described in detail with reference to the drawings, wherein like reference numerals are used to refer to like elements throughout. In the following description, for purpose of explanation, numerous specific details are set forth in order to provide a thorough understanding of the aspects and features of the present invention and methods for achieving the aspects and features. However, the present invention is not limited to the embodiments disclosed hereinafter. It should be apparent that the teaching herein can be embodied in a wide variety of forms and that any specific matters defined in the description, such as the detailed construction and elements, is merely representative. Based on teachings herein one skilled in the art should appreciate that an aspect disclosed herein can be implemented independently of any other aspects.

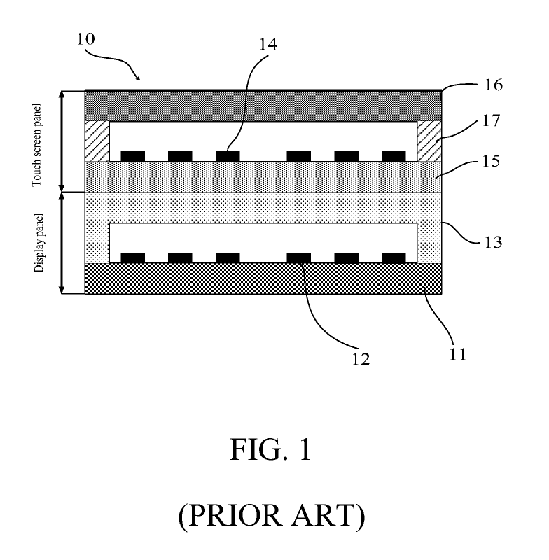

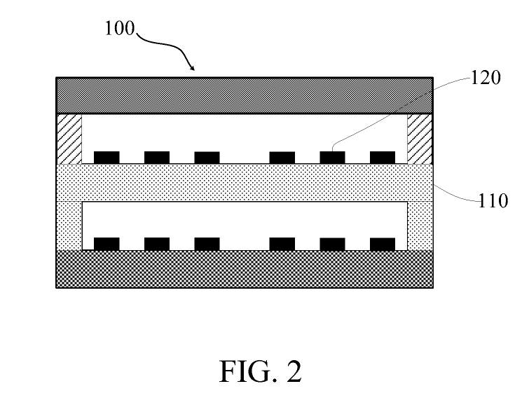

FIG. 2 illustrates a schematic configuration of a touch screen panel according to a preferred embodiment of the present invention. Referring to FIG. 2, a transparent electrode 120 (an electrode for touch sensing) is directly formed on the encapsulation glass substrate 110, placed for covering and sealing the bare glass substrate on which circuits or pixels are formed. Compare to the conventional configuration of a touch screen panel as illustrated in FIG. 1, the configuration of the touch screen panel according to a preferred embodiment of the present invention reduces the number of the glass substrate by directly forming a transparent electrode or touch sensing on the encapsulation glass substrate without using a separate glass substrate 15 in FIG. 1 placed for forming the transparent electrode.

The touch screen panel formed with several sheets of glass substrates increases the manufacturing cost of the touch screen panel due to high price of a glass substrate. Other disadvantages of the overlaying layers of sheets of glass substrates or resin films include reduced light transmission of the touch screen panel and increase in touch screen thickness and weight. The configuration of the touch screen panel according to a preferred embodiment of the present invention can overcome the disadvantages of the conventional touch screen panel formed with several sheets of glass substrates.

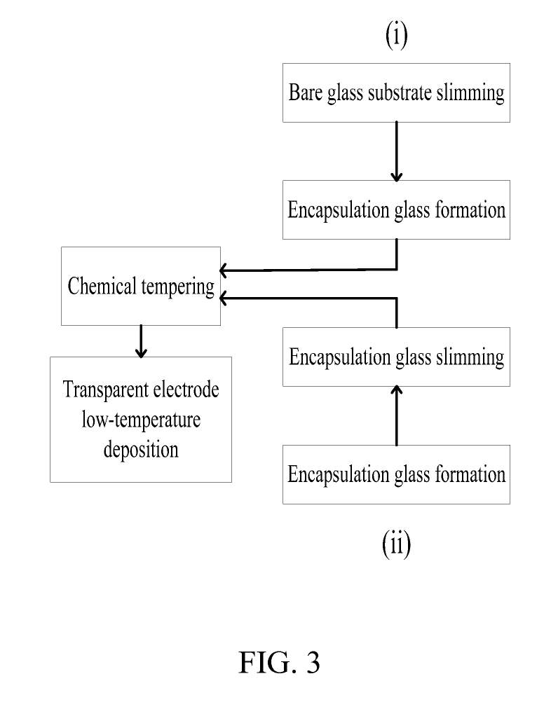

FIG. 3 illustrates an example process for manufacturing a transparent electrode integrated encapsulation module 100 in FIG. 2 of a preferred embodiment of the present invention. FIG. 3 provides two practical processes for manufacturing a transparent electrode integrated encapsulation module 100 of a preferred embodiment of the present invention.

### Process (i)

A large-area (e.g. 730×920 mm) of bare soda lime glass substrate is cut, chamfered, and then slimmed in order to make the thickness of the glass substrate after the slimming process to be from 0.05 to 0.5 mm. Since a lateral spray type of slimming can increase the defect rate by damaging the glass substrate due to increase of a pressure given to the glass substrate as the area of the glass substrate is increased, it is desirable to use the down-flow type method in which etching solution flow downward from the top of the large-area glass substrate in the vertically standing-up position.

Then the encapsulation glass substrate 110 is manufactured from the slimmed glass substrate. For the case of TFT-LCD, the encapsulation glass substrate is corresponds to a color filter substrate. The slimmed glass substrate is coated by dry-film coating such as epoxy resin coating or photoresist solution coating. And then, a mask pattern is formed for the encapsulation cavity formation. Using the mask pattern, the encapsulation cavity is formed by etching the encapsulation pattern, peeling off the dry-film coating, and then cleaning the encapsulation glass substrate.

The above-described cavity formation process may be omitted if a bare glass substrate for a circuit or pixel formation is sealed with a separate sealing means after the encapsulation glass substrate is formed in a flat state through the slimming process.

Since the slimmed encapsulation glass substrate 110 is too fragile to stand the subsequent processing steps or if the slimmed encapsulation glass substrate could not meet the requirement of strength in a specific application such as the case of mobile phone display, it may be necessary to temper the slimmed encapsulation glass substrate. The tempering process may be omitted, however, if there is an alternative method that can treat the slimmed glass substrate safely in the above processing steps or there is a slimmed glass substrate that can achieve the required strength.

Because an alkali-free glass cannot be tempered, a soda-lime glass is selected for chemically tempered the slimmed encapsulation glass substrate 110 of a preferred embodiment of the present invention to prevent the substrate 110 from being deformed or damaged in subsequent processing steps.

As a chemical tempering process step, the slimmed glass substrate 110 is put into a bath of potassium nitrate (KNO₃) and heated at a temperature from 380 to 450° C. for 2 to 8 hours (immersion and heating process). The bath of potassium nitrate is filled with potassium nitrate melted liquid that is made by heating a solid potassium nitrate above the melting temperature of 355° C.

Before the chemical tempering process, considering the weakness in the strength of the slimmed encapsulation glass substrate 110, the slimmed encapsulation glass substrate 110 is placed at a temperature of 300° C. by increasing the temperature gradually starting from room temperature (20 to 25° C.). The strength of glass is tempered due to replacement of a sodium ion (Na⁺) which is a component of soda-lime glass by a potassium ion (K⁺) through the above immersion and heating process.

Since a rapid cooling (cooling time less than 30 minute) of the slimmed glass substrate heated above the temperature of 380° C. can deform the properties of the slimmed glass substrate, the slimmed encapsulation glass substrate 110 is gradually cooled down to room temperature (20 to 25° C.).

After formation of the chemically tempered slim encapsulation glass substrate 110, the transparent electrode 120 is formed on the encapsulation glass substrate 110. The transparent electrode 120 of the present embodiment is composed of ITO (Indium Tin Oxide) electrode, but not limited thereto, and it may be formed with other materials such as ZnO.

A special attention may be required in formation of the transparent electrode 120 since a high deposition temperature of 300 to 800° C. used in the conventional deposition processed could make the chemically tempering process ineffectual. In order to provide lower deposition temperature between 150 to 250° C., an IPVD (Inductively coupled plasma Physical Vapor Deposition) method is selected for forming the transparent electrode 120 in the present embodiment. Another deposition method using a neutral beam may also be used as a low-temperature deposition process.

As an alternative to the IPVD method, a laminating method at room temperature (20 to 25° C.) is selected for the transparent electrode 120 in the present embodiment. After forming the ITO circuit using the laminating method at room temperature (20 to 25° C.), the ITO circuit is heated locally to crystallize the ITO material using laser irradiation. The irradiation time should be set dependent on the output of a laser used in the heating process. For the case of using EXCIMER laser or YAG laser, the ITO material is crystallized in a few μ seconds at an irradiation temperature 180° C.

### Process (ii)

The process (ii) is nearly the same as the process (i), however, a bare glass substrate is formed as an encapsulation glass substrate before the bare glass substrate is slimmed. The process may be applied when it is difficult to form a cavity for the encapsulation glass substrate after the slimming of the encapsulation glass substrate. Following steps after the formation of the slimmed encapsulation glass substrate are the same as in the process (i).

What is claimed is:

1. A transparent electrode integrated encapsulation module in which a transparent electrode is formed on an encapsulation glass substrate without a separate glass substrate for electrode formation of a touch screen circuit.

2. The transparent electrode integrated encapsulation module of claim 1, wherein the encapsulation glass substrate is slimmed in thickness from 0.05 to 0.5 mm, tempered in potassium nitrate (KNO₃) melted liquid at a temperature from 380 to 450° C., and deposited with a transparent electrode formed on the encapsulation glass substrate at a temperature from 150 to 250° C. .

3. A method for manufacturing a transparent electrode integrated encapsulation module, comprising:
a step of slimming an encapsulation glass substrate in thickness from 0.05 to 0.5 mm; and
a step of forming a transparent electrode circuit on the slimmed encapsulation glass substrate.

4. The method of claim 3, further comprising:
a step of forming a cavity on the surface of the slimmed encapsulation glass substrate, after the step of slimming of the encapsulation glass substrate.

5. The method of claim 3, further comprising:
a step of chemically tempering the slimmed encapsulation glass substrate, after the step of slimming of the encapsulation glass substrate.

6. The method of claim 4, further comprising:
a step of chemically tempering the slimmed encapsulation glass substrate, after the step of formation of the cavity on the surface of the slimmed encapsulation glass substrate.

7. The method of claim 5, wherein the slimmed encapsulation glass substrate is heated in potassium nitrate (KNO₃) melted liquid at a temperature from 380 to 450° C. .

8. The method of claim 6, wherein the slimmed encapsulation glass substrate is heated in potassium nitrate (KNO₃) melted liquid at a temperature from 380 to 450° C. .

9. The method of claim 7, wherein a step of forming the transparent electrode on the slimmed and tempered encapsulation glass substrate is an IPVD process at a temperature from 150 to 250° C.

10. The method of claim 7, wherein the step of forming the transparent electrode on the slimmed and tempered encapsulation glass substrate includes:
a step of applying a transparent electrode material on the said encapsulation glass at a temperature from room temperature to 150° C.; and
a step of irradiating laser to the transparent electrode material locally to crystallize the transparent electrode material.

11. The method of claim 8, wherein a step of forming the transparent electrode on the slimmed and tempered encapsulation glass substrate is an IPVD process at a temperature from 150 to 250° C.

12. The method of claim 8, wherein the step of forming the transparent electrode on the slimmed and tempered encapsulation glass substrate includes:
a step of applying a transparent electrode material on the said encapsulation glass at a temperature from room temperature to 150° C.; and
a step of irradiating laser to the transparent electrode material locally to crystallize the transparent electrode material.

13. A transparent electrode integrated encapsulation module in which a transparent electrode is formed on an encapsulation glass substrate without a separate glass substrate for electrode formation of a touch screen circuit, wherein the encapsulation glass substrate is slimmed in thickness from 0.05 to 0.5 mm.
